(19) United States
(12) Patent Application Publication
(10) Pub. No.: US 2026/0357625 A1
(43) Pub. Date: Nov. 12, 2026

(54) ADJUSTABLE BASE FOR MOUNTING HINGES FOR ITEMS OF FURNITURE

(71) Applicant: D.G.N. S.R.L., MODENA (IT)

(72) Inventor: Daniele ZETTI, REGGIO EMILIA (IT)

(73) Assignee: D.G.N. S.R.L., MODENA (IT)

(21) Appl. No.: 19/129,964

(22) PCT Filed: Nov. 9, 2023
(86) PCT No.: PCT/EP2023/081348

§ 371 Date: May 14, 2025

(30) Foreign Application Priority Data
Nov. 18, 2022 (IT) 102022000023802

(51) Int. Cl. E05D 7/04

(52) U.S. Cl. CPC E05D 7/0415; E05D 2007/0469; E05Y 2600/12; E05Y 2600/31

(57) ABSTRACT

An adjustable base for mounting hinges for items of furniture, comprising a fixing element configured to be associated with a component of an item of furniture, a supporting element to be associated with at least one component of a hinge, guiding element of sliding guidance of the supporting element with respect to the fixing element along a longitudinal direction, and sliding actuation elements, along the longitudinal direction, of the supporting element with respect to the fixing element; the guiding elements comprise at least one female element associated with one of either the fixing element and the supporting element or at least one male element associated with the other one of either the fixing element or the supporting element, the at least one female element and the at least one male element being coupled together to slide relative to each other along the longitudinal direction.

The present invention relates to an adjustable base for mounting hinges for items of furniture.

With specific, but not exclusive, reference to the furniture sector, “snap-acting” hinges are known, which are substantially constituted by a system of articulated levers with associated springs which make it possible to move door leaves that swing with respect to the fixed structure of an item of furniture, between a closed configuration and an open one. Such hinges generally have perforated coupling elements for mounting, using threaded elements or the like, inside the door leaf and the structure of the item of furniture.

Holes are provided on the door leaf and on the structure of the item of furniture, and the distribution of these holes matches with that of the holes of the coupling elements of the hinge to be mounted, by inserting threaded fixing elements.

In order to allow the adjustment of the position of the hinge with respect to the door leaf and/or with respect to the structure of the item of furniture, it is known to provide slotted openings on the coupling elements into which the stems of the threaded elements are inserted so as to pass through with play, in order to allow different positions of the hinge, so as to compensate any geometric and dimensional tolerances of production or of assembly of the components of the item of furniture.

However, this solution is rather impractical during the assembly step because the operator has to proceed by attempts until he or she identifies the optimal position of the hinge, loosening and retightening the threaded elements each time, with considerable lengthening of the time for labor and consequent increase of the incidence of labor costs, as well as the risk of obtaining in any case an assembled configuration that is still not optimal.

Alternatively, hinges are known which are provided with an attachment base that incorporates an adjustment system.

For example a solution is known which provides the base for attaching to the structure of the item of furniture, which is composed of a fixing element adapted to be connected to the item of furniture, and a supporting element for the articulated levers of the hinge which is associated so that it can slide longitudinally with the fixing element, between which an eccentric actuation assembly for relative sliding is interposed.

To guide the sliding of the supporting element with respect to the fixing element, there can be a shape mating between these elements, or the supporting element can have, along the mutually opposite longitudinal edges, wings folded to enfold the corresponding sides of the fixing element which act as guides.

Furthermore the sliding actuation assembly is generally provided with an actuation head which can be operated by a tool, which is positioned laterally with respect to the longitudinal central plane of the hinge.

These conventional adjustment systems are not devoid of drawbacks, among which is the fact that they feature considerable structural complexity in that the corresponding components have shape structures that are complex to make and to put together.

In addition, the fact that the actuation head of the actuation assembly is positioned laterally can lead to the supporting element becoming wedged against the anchoring element during movement, with consequent limitation of relative sliding capacity, and malfunctioning of the adjustment system.

Also, the lateral positioning of the actuation head makes access to it difficult in some applications.

Last but not least, conventional adjustment systems bring an overall increase in the bulk of the hinges, and a substantial alteration of its outer shape, thus rendering their installation more complicated.

The aim of the present invention is to eliminate the above-mentioned drawbacks in the background art by providing an adjustable base for mounting hinges for items of furniture that offers a structure that is simple both to provide and to assemble.

Within this aim, an object of the present invention is to enable an easy and reliable adjustment in the step of mounting the hinge on the item of furniture.

Another object of the present invention is to be able to adapt it to different types of hinges, and to be able to apply it both on the door leaf and on the fixed structure of the item of furniture.

Another object of the present invention is for it to be compact, so as to substantially modify the overall bulk and outline of the hinge in which it is incorporated, so as to not complicate its installation.

Another object of the present invention is to provide a simple structure that is easy and practical to implement, safe in use and effective in operation, and of low cost.

This aim and these and other objects that will become more apparent hereinafter are all achieved by the present adjustable base for mounting hinges for items of furniture according to the appended main and independent claim 1 below, and optionally provided with one or more of the characteristics recited in the subsequent dependent claims.

This aim and these and other objects are likewise achieved by a hinge for items of furniture that incorporates the base according to the invention.

Further characteristics and advantages of the present invention will become more apparent from the detailed description of two preferred, but not exclusive, embodiments of an adjustable base for mounting hinges for items of furniture, illustrated for the purposes of non-limiting example in the accompanying drawings wherein:

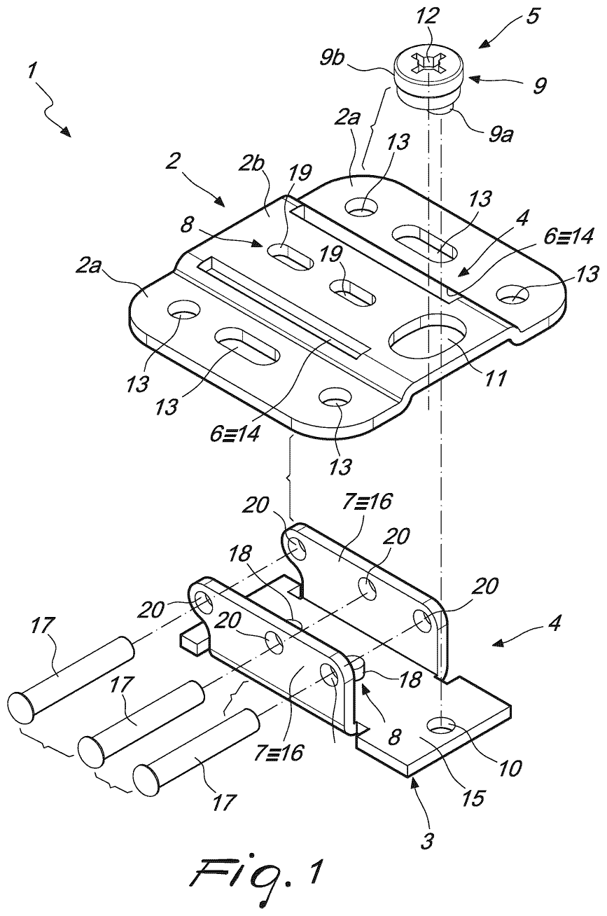

FIG. 1 is an exploded perspective view of a first embodiment of an adjustable base for mounting hinges for items of furniture, according to the invention;

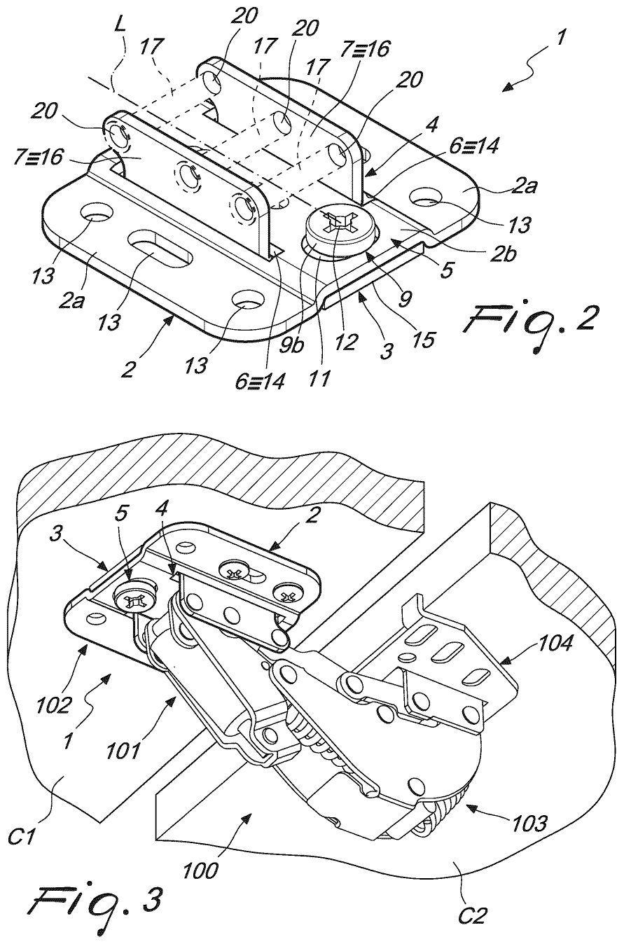

FIG. 2 is a perspective view of the first embodiment of the adjustable base according to the invention in the assembled configuration;

FIG. 3 is a perspective view of the base of FIG. 2 applied to a hinge mounted between a door leaf and the structure of an item of furniture in a first active configuration;

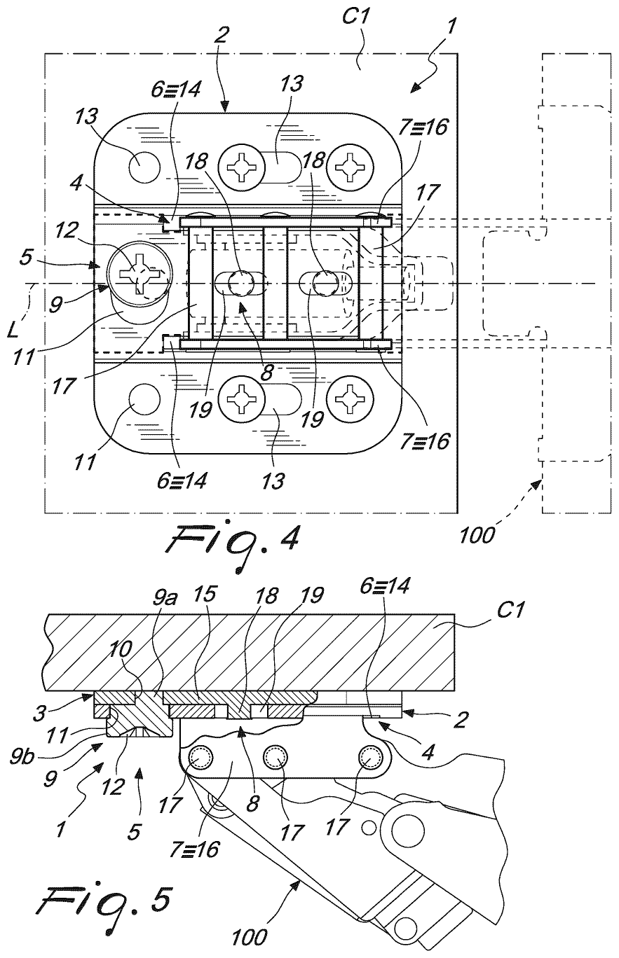

FIG. 4 is a view from below of the base of FIG. 3;

FIG. 5 is a partially cross-sectional side view of a portion of the hinge of FIG. 3 at the base according to the invention;

FIG. 6 is a view of the base of FIG. 4 with the base according to the invention in a second active configuration;

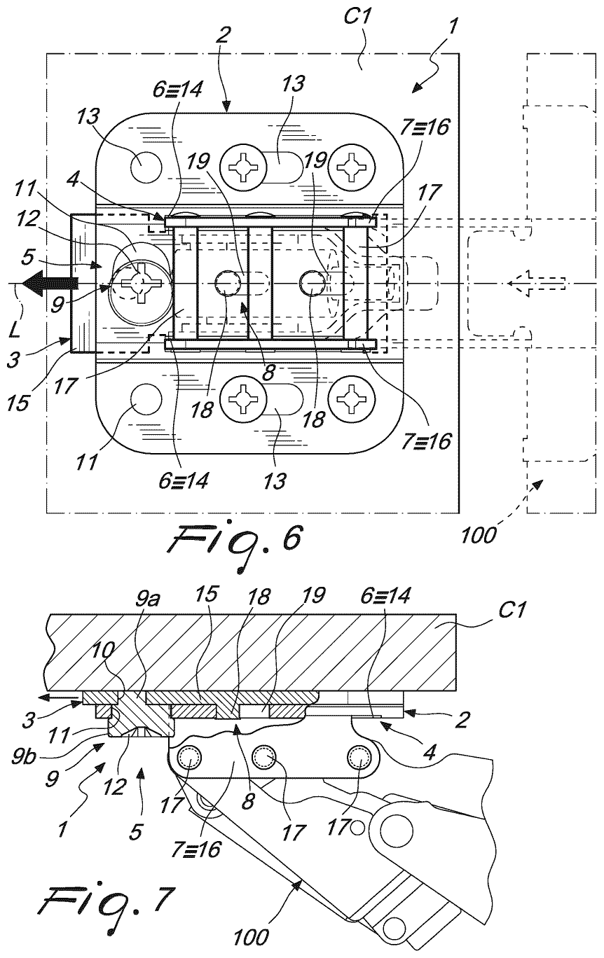

FIG. 7 is a view of the hinge of FIG. 5 with the base according to the invention in a second active configuration;

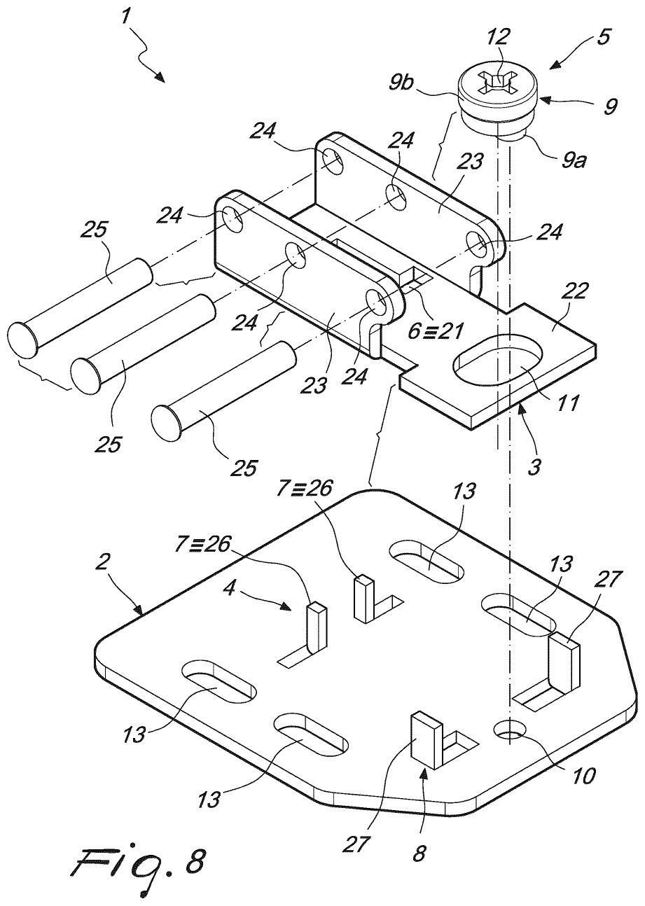

FIG. 8 is an exploded perspective view of a second embodiment of an adjustable base for mounting hinges for items of furniture, according to the invention;

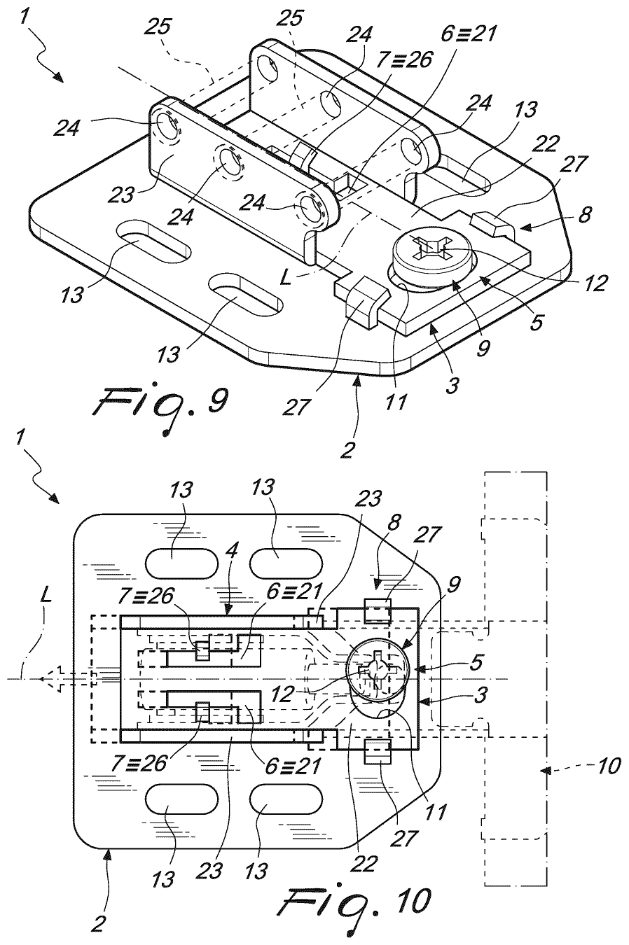

FIG. 9 is a perspective view of the second embodiment of the adjustable base according to the invention in the assembled configuration;

FIG. 10 is a plan view of the second embodiment of the base according to the invention.

With reference to the figures, the reference numeral 1 generally designates an adjustable base for mounting hinges for items of furniture.

The base 1 comprises a fixing element 2 which can be associated with a component of an item of furniture, a supporting element 3 which can be associated with at least one component of a hinge, guiding means 4 of sliding guidance of the supporting element 3 with respect to the fixing element 2 along a longitudinal direction L, and actuation means 5 for the sliding actuation, along the longitudinal direction L, of the supporting element 3 with respect to the fixing element 2.

Preferably the actuation means 5 make it possible to move the supporting element 3 with respect to the fixing element 2 by sliding alternately along the longitudinal direction L.

The adjustment of the relative position of the fixing element 2 and the supporting element 3 along the longitudinal direction L make it possible to modify the relative position of the components of the item of furniture that are connected by the hinge in which the base 1 is incorporated.

The guiding means 4 comprise at least one female element 6 associated with one of either the fixing element 2 and the supporting element 3 or at least one male element 7 associated with the other one of either the fixing element 2 or the supporting element 3. The at least one female element 6 and the at least one male element 7 are coupled together so that they can slide relative to each other along the longitudinal direction L.

The fixing element 2 is generally provided with a plurality of holes or openings 13 for the insertion of elements for connecting to a component of an item of furniture.

When in use the base 1 is incorporated in a conventional hinge 100 of the type that comprises a first articulated quadrilateral 101 provided with a first coupling element 102 which can be associated with a first component C1 of the item of furniture and a second articulated quadrilateral 103 provided with a second coupling element 104 which can be associated with a second component C2 of the item of furniture, the hinge 100 being adapted to assume alternately an open configuration and a closed configuration in which at least one of the components C1 and C2 assumes a different position with respect to the other. One or both of the coupling elements 102 and/or 104 can comprise a base 1 as described below.

By way of example, in FIGS. 3-7 the hinge 100 is shown with the first coupling element 102 connected to a first, fixed component C1 of an item of furniture (for example a wall of the structure of the item of furniture) and the second coupling element 104 connected to a second, movable element C2 of the same item of furniture (for example a door leaf or door) and with the base 1 associated with the first coupling element 102, but alternative embodiments are not ruled out.

The hinge 100 is generally provided with elastic means associated with the articulated quadrilaterals 101 and 103 which cooperate in the movement between the open configuration and the closed configuration, and can comprise damping means that act when the hinge is being closed and/or opened, such means not being shown and described in detail as they are conventional.

Furthermore the base 1 can comprise sliding reference means 8 along the longitudinal direction L, which are interposed between the fixing element 2 and the supporting element 3.

Such reference means 8 facilitate maintaining the alignment of the fixing element 2 and the supporting element 3 along the longitudinal direction L.

Advantageously the actuation means 5 are arranged at one end of the base 1 along the longitudinal direction L so as to be easily accessible in use.

In addition, the actuation means 5 comprise an eccentric pin 9 rotationally engaged in a seat 10 associated with one of either the fixing element 2 or the supporting element 3, and is accommodated so that it can move within a slot 11 substantially transverse to the longitudinal direction L which is associated with the other one of either the fixing element 2 or the supporting element 3.

The seat 10 and the slot 11 are defined at the midpoint of the fixing element 2 and of the supporting element 3. The seat 10 and the slot 11 are defined at a longitudinal end of the base 1.

The eccentric pin 9 is comprised of a cylindrical stem 9a engaged rotationally in the seat 10, and a circular head 9b misaligned with respect to the stem, which can move within the transverse slot 11.

Conveniently the circular head 9b presents a minimal protrusion outside of the slot 11, so as not to interfere, in use, with the components of the hinge 100 in the open and closed configurations.

Longitudinally the slot 11 presents a dimension that coincides substantially with the diameter of the circular head 9b, while it presents a greater transverse extension.

The circular head 9b abuts against diametrically mutually opposite portions of the periphery of the slot 11 (FIGS. 4, 6, 10), thus actuating the sliding of the supporting element 3 with respect to the fixing element 2. With respect to the slot 11, the eccentric pin 9 can move between a first and a second active position (FIGS. 4 and 6), which correspond to different relative positions of the fixing element 2 and the supporting element 3 along the longitudinal direction L.

The eccentric pin 9 comprises driving means 12 for rotational actuation with respect to the seat 10. Such driving means 12 can comprise a coupling seat which can be associated with a tool for rotationally actuating the eccentric pin 9.

In the embodiments shown, the driving means 12 are constituted by a cross head notch defined on the circular head 9b of the eccentric pin 9 for inserting a flat head screwdriver or the like, but they could have a linear notch or a hexagonal socket for coupling with a different tool for the rotational actuation of the pin.

By modifying the angular configuration of the eccentric pin 9 it is possible to vary the relative position of the supporting element 3 with respect to the fixing element 2. When the base 1 is incorporated in a hinge 100, by means of this adjustment it is possible to vary the position of the hinge with respect to the fixing element 2 and, as a consequence, modify the position of the components of the item of furniture C1 and C2 between which it is mounted.

In a first embodiment the at least one female element 6 is associated with the fixing element 2 and the at least one male element 7 is associated with the supporting element 3.

In this case the at least one male element 7 can move by sliding alternately along the longitudinal direction L with respect to the at least one female element 6.

FIGS. 1-7 show a first embodiment of the invention.

Preferably the at least one female element 6 is constituted by a slot 14 defined on the fixing element 2. Such slot 14 has an elongated shape and extends substantially parallel to the longitudinal direction L.

In the present description the term “substantially” means “except for the usual tolerances in machining and assembly of the component parts”.

In more detail, the fixing element 2 comprises two lateral wings 2a which are substantially mutually coplanar and between which a raised portion 2b is interposed. The fixing element 2 can be made for example of a shaped and formed sheet metal. The at least one slot 14 is defined at the raised portion 2b. The holes or openings 13 are distributed at the lateral wings 2a.

The supporting element 3 comprises a plate 15 associated with at least one shoulder 16 for supporting the at least one component of the hinge 100 that defines the at least one male element 7.

The at least one shoulder 16 extends substantially perpendicular to the plate 15 and parallel to the longitudinal direction L

The supporting element 3 can be made of a shaped and folded metal.

Preferably the supporting element 3 comprises two, mutually spaced apart and substantially parallel shoulders 16, arranged on opposite sides of the plate 15.

Each shoulder 16 can be provided with a plurality of holes 20, aligned in pairs transversely to the longitudinal direction, for the introduction of respective pins 17 for articulation/connection to the base 1 of the components of the hinge 100.

The guiding means 4 therefore comprise two male elements 7, each one defined by a respective shoulder 16, and two female elements 6, each one defined by a respective slot 14. Each shoulder 16 is inserted so that it can slide along a respective slot 14.

The two slots 14 are arranged mutually spaced apart and substantially parallel to the longitudinal direction L.

The slots 14 have a greater longitudinal extension than the shoulders 16.

In the assembled configuration (FIG. 2) the plate 15 is accommodated between the lateral wings 2a and the raised portion 2b of the fixing element 2.

In this case the seat 10 is defined in the plate 15 and the slot 11 in the raised portion 2b.

The reference means 8 can comprise, for example, at least one pin 18 protruding from the plate 15 toward the raised portion 2b and coupled so that it can slide along an elongated opening 19 along the longitudinal direction L defined on the raised portion. Preferably the reference means 8 comprise two pintles 18, inserted so that they can slide along respective openings 19.

In a second embodiment the at least one female element 6 is associated with the supporting element 3 and the at least one male element 7 is associated with the fixing element 2.

In this case the at least one female element 6 can move by sliding alternately along the longitudinal direction L with respect to the at least one male element 7.

FIGS. 8-10 show a possible implementation of the second embodiment of the invention.

The at least one female element 6 comprises a window 21 defined on the supporting element 3. Such window 21 extends substantially parallel to the longitudinal direction L.

In this case too, the supporting element 3 comprises a plate 22 of elongated shape along the longitudinal direction L, which has two shoulders 23 arranged on opposite sides of the plate, and substantially at right angles to it, which are substantially parallel to the longitudinal direction L. The at least one window 21 is defined at the plate 22.

Each shoulder 23 can be provided with a plurality of holes 24, aligned in pairs transversely to the longitudinal direction, for the introduction of respective pins 25 for articulation/connection to the base 1 of the components of the hinge 100.

The supporting element 3 can be made of a shaped and folded sheet metal.

The fixing element 2 comprises at least one tooth 26 which protrudes toward the supporting element 3 and defines the at least one male element 7.

The fixing element 2 has a substantially plate-like shape.

The tooth 26 can be defined by a flap of the lamina that constitutes the fixing element 2, die-cut and folded in order to be inserted through the window 21.

Once assembled, the tooth 26 has a curved shape, i.e. folded toward the plate 22.

Preferably the guiding means 4 comprise two female elements 6 constituted by respective windows 21 substantially parallel to the longitudinal direction L defined in the plate 22, and two male elements 7 defined by respective teeth 26 which protrude from the fixing element 2. Each tooth 26 is inserted along a corresponding window 21 so that the supporting element 3 that contains the windows can move along the longitudinal direction L with respect to the fixing element 2.

In this case the seat 10 is defined in the fixing element 2 and the slot 11 in the plate 15.

The reference means 8 can comprise, for example, a pair of wings 27 die-cut in the fixing element 2 and folded onto the edges of the plate 22.

In practice it has been found that the base according to the invention as described achieves the intended aim and objects and, in particular, attention is drawn to the fact that the base according to the invention has components that are easy to provide and assemble, and the base makes it possible to easily perform a reliable adjustment of the hinge during assembly.

Furthermore the base according to the invention can be easily adapted to many and varied types of hinges with minimal structural adaptations.

Lastly, the base according to the invention is compact and does not significantly alter the bulk and outline of the hinge in which it is incorporated, so as to not complicate its installation.

The invention thus conceived is susceptible of numerous modifications and variations, all of which are within the scope of the appended claims.

Moreover, all the details may be substituted by other, technically equivalent elements.

In practice the materials employed, as well as the contingent dimensions and shapes, may be any according to requirements without for this reason departing from the scope of protection claimed herein.

The disclosures in Italian Patent Application No. 102022000023802 from which this application claims priority are incorporated herein by reference.

1.-17. (canceled)

18. An adjustable base for mounting hinges for items of furniture, which comprises:
a fixing element, which is configured to be associated with a component of an item of furniture,
a supporting element, which is configured to be associated with at least one component of a hinge,
guiding means for the sliding guidance of said supporting element with respect to said fixing element along a longitudinal direction,
actuation means for the sliding actuation, along said longitudinal direction, of said supporting element with respect to said fixing element,
wherein said guiding means comprise at least one female element associated with one of either said fixing element and said supporting element or at least one male element associated with the other one of either said fixing element or said supporting element, the at least one female element and the at least one male element being coupled together so that they can slide relative to each other along the longitudinal direction.

19. The base according to claim 18, wherein said at least one female element is associated with said fixing element and wherein said at least one male element is associated with said supporting element, the at least one male element being movable by sliding alternately along the longitudinal direction with respect to the at least one female element.

20. The base according to claim 18, wherein the at least one female element comprises a slot defined on said fixing element.

21. The base according to claim 18, wherein said fixing element comprises two lateral wings between which a raised portion associated with said at least one female element is interposed.

22. The base according to claim 19, wherein said supporting element comprises a plate associated with at least one shoulder for supporting said at least one component of said hinge that defines said at least one male element.

23. The base according to claim 18, wherein said guiding means comprise two of said female elements, which comprise respective slots associated with said fixing element, and two of said male elements, which are defined by respective shoulders of said supporting element, each shoulder being inserted so that it can slide along a respective slot.

24. The base according to claim 18, wherein said at least one female element is associated with said supporting element and wherein said at least one male element is associated with said fixing element, the at least one female element being movable by sliding alternately along the longitudinal direction with respect to the at least one male element.

25. The base according to claim 18, wherein the at least one female element comprises a window defined on said supporting element.

26. The base according to claim 18, wherein said supporting element comprises a plate to which at least one shoulder is connected, said at least one female element being positioned at said plate.

27. The base according to claim 18, wherein said fixing element comprises at least one protruding tooth which defines said at least one male element.

28. The base according to claim 27, wherein said at least one tooth is curved.

29. The base according to claim 27, wherein said guiding means comprise two of said female elements which comprise respective windows associated with said supporting element and two of said male elements defined by respective protruding teeth of said fixing element, each tooth being inserted with play along a respective window.

30. The base according to claim 18, further comprising sliding reference means interposed between said fixing element and said supporting element.

31. The base according to claim 18, wherein said actuation means are arranged at one end of said base along said longitudinal direction.

32. The base according to claim 18, wherein said actuation means comprise an eccentric pin rotationally engaged in a seat associated with one of either said fixing element or said supporting element and is accommodated so that it can move within a slot substantially transverse to said longitudinal direction which is associated with the other one of either said fixing element or said supporting element.

33. The base according to claim 32, wherein said eccentric pin comprises driving means for rotational actuation with respect to said seat.

34. A hinge for items of furniture, which comprises a first articulated quadrilateral provided with a first coupling element which is configured to be associated with a first component of an item of furniture and with a second articulated quadrilateral provided with a second coupling element which can be associated with a second component of said item of furniture, the hinge being adapted to assume alternately an open configuration and a closed configuration, wherein at least one of said coupling elements comprises a base according to claim 18.
